(19) United States
(12) Patent Application Publication
(10) Pub. No.: US 2016/0239264 A1
(43) Pub. Date: Aug. 18, 2016

(54) RE-STREAMING TIME SERIES DATA FOR HISTORICAL DATA ANALYSIS

(71) Applicant: GE INTELLIGENT PLATFORMS, INC., Charlottesville, VA (US)

(72) Inventors: Sunil Mathur, Foxboro, MA (US); Kareem Sherif Aggour, Niskayuna, NY (US); Ward Linnscott Bowman, Foxboro, MA (US); Jerry Lin, Niskayuna, NY (US)

(21) Appl. No.: 14/911,090

(22) PCT Filed: Jun. 10, 2013
(86) PCT No.: PCT/US13/44964

§ 371 Date: Feb. 9, 2016

(51) Int. Cl. G06F 7/36; G06F 17/30; G06N 5/04; H04L 29/08

(52) U.S. Cl. CPC G06F 7/36; H04L 67/10; G06F 17/30867; G06N 5/047

(57) ABSTRACT

Time series data is received from a time series data repository and the time series data includes a plurality of sub-portions. The sub-portions of data are first sorted in chronological order to appear as if the data is being generated in real time and are then sent for analysis. The received sorted time series data is then analyzed to detect one or more predefined events or patterns in the data. When the predefined events or patterns are detected in the time series data by the analysis, a user or downstream analysis component is informed that the one or more predefined events or patterns have been found.

### BACKGROUND OF THE INVENTION

1. Field of the Invention

The subject matter disclosed herein relates to processing time series data and, more specifically, determining whether the time series data contains predefined patterns.

2. Brief Description of the Related Art

Data is stored on data storage devices in a variety of different formats. Additionally, various types of data storage devices are used to store data and these data storage devices may vary in cost. In one example, data may be stored according to certain formats on high cost devices such as random access memories (RAMs). In other examples, data may be stored on low cost devices such as on hard disks.

One type of data that is stored is time series data. In one aspect, time series data is obtained by some type of sensor or measurement device and is stored as a function of time. For example, a measurement sensor may take a reading of a parameter at predetermined time intervals, and each of the measurements is stored in memory. Since large amounts of data are typically involved with time series measurements, the storage of this data becomes particularly cumbersome.

The volume of time series data has gown exponentially over time, and this growth presents a unique set of challenges when attempting to store and mine historical data for analysis. Previous approaches for querying time series datasets require retrieving large amounts of data from a data repository at one time and executing an analytic on that complete dataset, discarding any data that is not required on the client side after the data has been transferred.

Unfortunately, the accessing of large pieces of data is inefficient, slow, and costly. User dissatisfaction has resulted from these previous approaches.

### BRIEF DESCRIPTION OF THE INVENTION

The approaches described herein provide re-streaming of time series data that minimizes the need to access large pieces of data at once thereby reducing the amount of large-scale input/output (I/O) operations and memory footprint that can slow processing. The re-streaming of time series data in the present approach accesses the time series data repository and retrieves data elements in small sets and send them onward for further processing through a stream-based operation. In sonic aspects, the re-streamed data is time-synchronized such that the data is replayed in chronological order. Further, depending on the specific analytic requirements, the data may be properly spaced such that a separation (e.g., n seconds) between two data points in the repository appears as a separation (e.g., n seconds) in the data that is being re-streamed.

In the present approaches, a defined set of time series events can be subscribed to by a user. Additionally, an event producer may re-strewn the historical data and actively looks for subscribed events, emitting them as they are found. Further, consumers or users may receive the data associated with the events as the event is detected.

As mentioned, the present approaches obtain small pieces of time series data and re-stream the subset of the time series data as though it were being generated in real time. In some aspects, the stream is analyzed and events are generated from historical time series data. Those events could then be subscribed to and consumed by different analytics further downstream. Events that could be generated include, but are not limited to, operations to reduce the size of the data (such as sampling operations or aggregation operations) or more complex pattern matching functions across single or multiple parameters at a point in time or over time. Other examples of analysis are possible.

In many of these embodiments, time series data is received from a time series data repository and the time series data includes a plurality of sub-portions. The sub-portions of data are sorted in chronological order to appear as if the data is being generated in real time arid are sent onward for further processing. The received and sorted time series data is analyzed to determine if one or more predefined events or patterns are found within the data. If one or more predefined events or patterns are found in the time series data by the analysis, a user is informed that the one or more predefined events or patterns have been detected or discovered.

In some aspects, at least some of the one or more predefined events or patterns are subscribed to by the user. In other aspects, the predefined events or patterns include an operation to reduce the size of the data and a pattern matching operation. Other examples of analytics are possible.

In some examples, the time series data repository is stored within a cloud or cloud-based network. In other examples, the predefined event or pattern is stored in a data library.

In others of these embodiments, an apparatus that is configured to re-stream stored time series data includes an interface and a controller. The interface has an input and output and is configured to receive time series data from a time series data repository. The time series data includes a plurality of sub-portions and when the sub-portions of data are returned, they are returned sorted in chronological order to appear as if the data is being generated in real time.

The controller is coupled to the interface and is configured to analyze the received and sorted time series data to determine if one or more predefined events or patterns occurred in the data. The controller is further configured to when the predefined events or patterns are detected in the time series data by the analysis, to inform a user at the output that the one or more predefined events or patterns have been discovered.

### BRIEF DESCRIPTION OF THE DRAWINGS

For a more complete understanding of the disclosure, reference should be made to the following detailed description and accompanying drawings wherein:

FIG. 1 comprises a block diagram of an approach for re-streaming time series data according to various embodiments of the present invention;

FIG. 2 comprises a flow chart of an approach for re-streaming time series data according to various embodiments of the present invention; and

FIG. 3 comprises a block diagram of an apparatus for re-streaming time series data according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The approaches described herein provide for the re-streaming of time series data. In one aspect, a time series data repository can be searched and a subset of the time series data can be extracted and analyzed in chronological order. A re-streaming analytic execution engine may receive the data stream and execute the selected analytics against the stream, generating and emitting events as they are detected. In another aspect, a library of standard time series events is maintained that can be searched, and this allows users to specify which of those analytics to actively execute.

In still other aspects, a collection of event consumers is maintained. Users can subscribe to the events generated by a re-streaming execution engine. Each event consumer can communicate with the re-streaming execution engine to specify the specific events it is interested in receiving. The re-streaming execution engine understands which events to monitor and where to send those events when the events are detected. In one advantage of the present approaches, a common approach is provided by which historical and current data are analyzed, analytics become easier to build and maintain since the same analytic is used to do exploration on historical data and event detection on live data streams in real-time. This contrasts with previous data mining which required analytics to be built twice: once to mine and build analytic models on historical data, and a second time to turn that new model into an analytic that can be executed in real time.

Another advantage of the present approaches is that they allow for events/results to be analyzed as they are found during data exploration. In other words, the entire historical dataset would not have to be completely processed before the detected historical events of interest can be utilized. This reduces the time to make decisions and gain business value from the historical data.

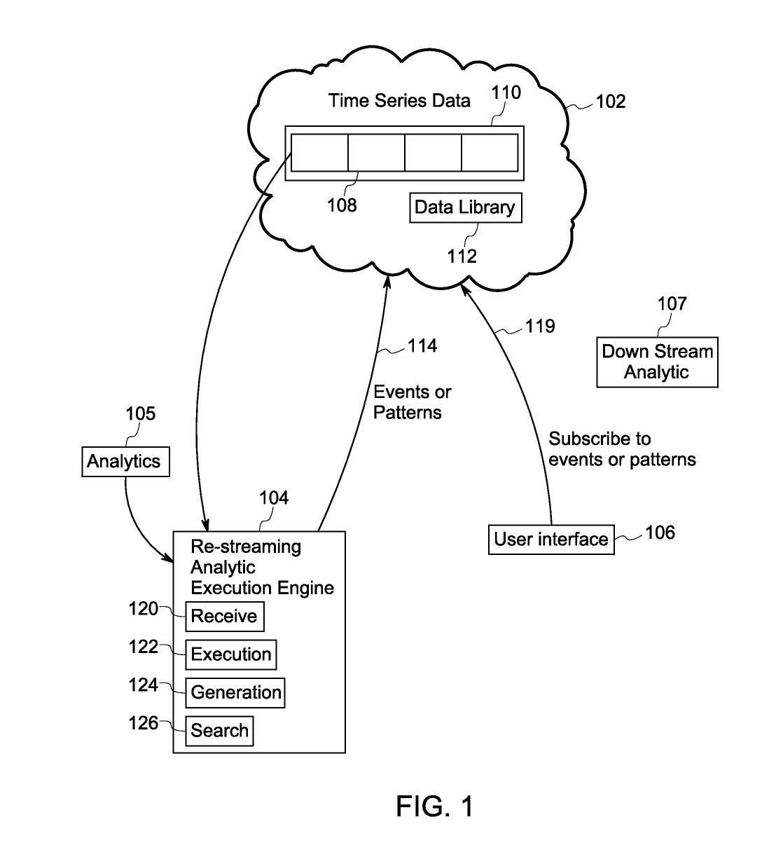

Referring now to FIG. 1, one example of a system 100 for re-streaming time series data is described. The system 100 includes a cloud-based network 102, a re-streaming analytic execution engine 104, and a user interface 106. Time series data 108 is stored at a time series data repository 110. An analytic library 112 may be located within the same repository as the time series data repository 110 or may be a separate entity as shown here.

The re-streaming analytic execution engine 104 may include a receive module 120 that receives the chronologically sorted the time series data stream; an execution module 122 that executes selected analytics 105 against the stream; a generation module 124 that generates and emits events as they are detected; and a search module 126 (that searches for patterns or events in the time series data). The re-streaming analytic execution engine 104 may be located in the cloud-based network 102 or outside the cloud-based network 102. It will be appreciated that the re-streaming analytic execution engine 104 may be disposed at the cloud-based network 102 or at various locations within and outside the cloud-based network 102.

The predefined events and patterns 114 may be a variety of different pieces of information. In some aspects, the predefined events or patterns include an operation to reduce the size of the data and a pattern matching operation. Other examples are possible.

The cloud-based network 102 is any combination of networks. For example, it may be any combination of the Internet, cellular phone networks, wide area networks or local area networks. Other types of networks and combinations of networks are possible.

The time series data repository 110 may in one example be a random access memory (RAM). However, it may be any type of memory storage device. The analytic library 112 may also be any type of data storage device.

The user interface 106 is any combination of hardware and software that allows a user to access information. For example, this may be a computer terminal with a mouse and a keyboard. Other examples of user interfaces are possible.

In one example of the operation of the system of FIG. 1, time series data 108 is received from a time series data repository 110 and the time series data 108 includes a plurality of sub-portions. The sub-portions of the time series data are sorted by the receive module 120 of the re-streaming analytic execution engine 104 in chronological order to appear as if the data is being generated in real time. Alternatively, the sub-portions may be sorted at the cloud-based network 102. The received and sorted time series data is then analyzed by the generation module 124 of the re-streaming analytic execution engine 104 to determine one or more predetermined events or patterns 114. When the predetermined events or patterns 114 are determined in the time series data 108 by the analysis, a user is informed via the user interface 106 that the one or more predetermined events or patterns have been detected or determined.

It will be appreciated that the modules 120, 122, 124, and 126 may be any combination of electronic hardware and software. For example, the modules 120, 122, 124, and 126 may be computer instructions that execute on general purpose processing devices.

In some aspects, at least some of the one or more predetermined events or patterns 114 are subscribed to by the user. This is accomplished via a subscribe to events or patterns message 119.

In some examples, the time series data repository 110 is disposed at the cloud-based network 102. In other examples, the predetermined event or pattern 114 is stored in the analytic library 112. In other examples, the analytics library 112 is searched by the re-streaming analytic execution engine 104 for a selected predefined event or pattern and analytics 105 to execute on the stream. In some other aspects, the predefined events or patterns 114 are consumed downstream by a downstream analytic 107. Examples of analytics 105 and 107 include event correlation, anomaly classification, or root cause analysis. Other examples are possible.

In another example of the operation of FIG. 1, the time series data repository 110 can be searched by the search module 126 of the re-streaming analytic execution engine 104 and a subset of the data can be extracted and analyzed in chronological order. The execution module 122 of the re-streaming analytic execution engine 104 may receive the sorted time series data stream and execute the selected analytics against the stream, the generation module 126 may then generate and emit events as they are detected. In another aspect, standard time series patterns or events are provided and stored in the analytics library 112 and this information can be searched by the re-streaming analytic execution engine 104. As a result, users can specify which analytics they wish to execute.

The re-streamed data (re-streamed by the re-streaming analytic execution engine 104) is time synchronized such that the data is replayed in chronological order. Further, depending on the specific analytic requirements, the data may be properly spaced such that a separation (e.g., n seconds) between two data points in the repository appears as a separation (e.g., it seconds) in the data re-stream.

In another example of the operation of the system of FIG. 1, a collection of event consumers, subscribe to the events generated by the re-streaming analytic execution engine 104. Each event consumer can communicate with the re-streaming analytic execution engine 104 to specify the specific events it is interested in receiving. The re-streaming analytic execution engine 104 thus knows which events to look for and where to send those events. Consequently, a common approach is provided by which historical and current data are analyzed, analytics become easier to build and maintain since the same analytic is used to do exploration on historical data and event detection on live data streams in real-time.

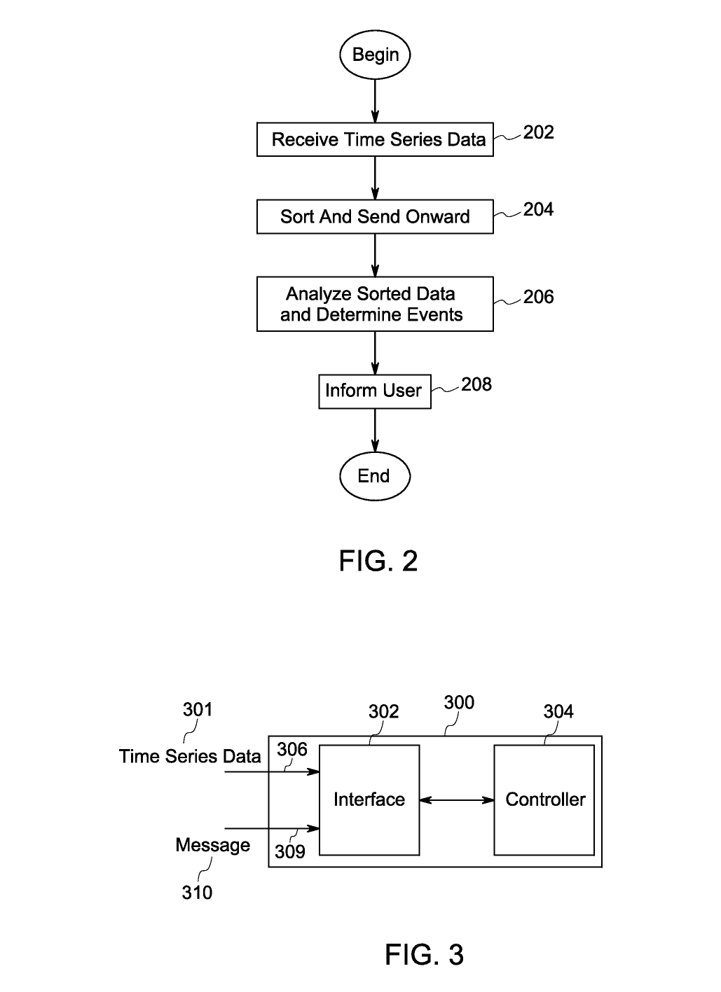

Referring now to FIG. 2, one example of an approach for re-streaming time series data is described. At step 202, time series data is received from a time series data repository and the time series data includes a plurality of sub-portions. At step 204, the sub-portions of data are sorted in chronological order and are then sent onward for further processing, such that the data appears as if it is being generated in real time. At step 206, the received time series data is analyzed to detect one or more predefined events or patterns. At step 208, when the predefined events or patterns are detected in the time series data by the analysis, a user is informed that the one or more predefined events or patterns have been found.

In some aspects, at least some of the one or more predefined events or patterns are subscribed to by the user. In other aspects, the predefined events or patterns include an operation to reduce the size of the data and a pattern matching operation. Other examples are possible.

In some examples, the time series data repository is disposed at a cloud or cloud-based network. In other examples, the predefined event or pattern is stored in an analytics library. In other examples, the analytics library is searched for analytics to execute to search for the selected predefined events or patterns. In some other aspects, the predetermined events or patterns are consumed downstream by a downstream analytic such as an event correlator or root cause analyzer.

Referring now to FIG. 3, one example of an apparatus 300 for re-streaming time series data 301 is described. The apparatus 300 may, in one example, be the re-streaming analytic execution engine 104 described with respect to FIG. 1. However, the apparatus 300 may also be disposed at multiple locations (rather than a single location) and may be based in a cloud-based network or outside a cloud-based network.

The apparatus 300 includes an interface 302 and a controller 304. The interface 302 has an input 306 and output 308 and is configured to receive time series data 301 from a time series data repository. The time series data includes a plurality of sub-portions and the sub-portions of data are returned sorted in chronological order to appear as if the data is being generated in real time. The sorting may be performed by the controller 304 or the time series data 301 may be received in already-sorted form.

The controller 304 is coupled to the interface 302 and is configured to analyze the received and now sorted time series data in order to detect one or more predefined events or patterns. The controller 304 is further configured to when the predefined events or patterns are detected in the time series data by the analysis, to inform a user at the output 308 by a message 310 that the one or more predefined events or patterns have been found.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method of re-streaming time series data, the method comprising,
receiving time series data from a time series data repository, the time series data comprising a plurality of sub-portions of the time series data;
sending the sub-portions of the time series data sorted in chronological order to appear as if the data is being generated in real time;
analyzing the received and sorted time series data to detect one or more predefined events or patterns; and
when the predefined events or patterns are detected in the time series data by the analyzing, informing a user that the one or more predefined events or patterns have been found.

2. The method of claim 1 further comprising subscribing to at least some of the one or more predefined events or patterns.

3. The method of claim 1 wherein the predefined events or patterns are selected from the group consisting of: an operation to reduce the size of the data and a pattern matching operation.

4. The method of claim 1 wherein the time series data repository is disposed at a cloud-based network.

5. The method of claim 1 further comprising storing the predefined event or pattern in an analytics library.

6. The method of claim 5 further comprising searching the analytics library for an analytic to execute to search for the selected predefined event or pattern.

7. The method of claim 1 further comprising consuming the predefined events or patterns downstream by a downstream analytic.

8. An apparatus that is configured to re-stream time series data, the apparatus comprising,
an interface having an input and output, the input configured to receive time series data from a time series data repository, the time series data comprising a plurality of sub-portions, the sub-portions sorted in chronological order to appear as if the sub-portions are being generated in real time;
a controller coupled to the interface, the controller configured to perform an analysis on the received and sorted time series data to detect one or more predefined events or patterns, the controller further configured to when the predefined events or patterns are detected in the time series data by the analysis, inform a user at the output that the one or more predefined events or patterns have been found.

9. The apparatus of claim 8 wherein a user subscribes to at least some of the one or more predefined events or patterns.

10. The apparatus of claim 8 wherein the one or more predefined events or patterns are selected from the group consisting of: an operation to reduce the size of the data and a pattern matching operation.

11. The apparatus of claim 8 wherein the time series data repository is disposed in a cloud-based network.

12. The apparatus of claim 8 wherein the predefined event or pattern are stored in an analytics library.

13. The apparatus of claim 12 wherein the analytics library is searched by the controller for a selected analytic to execute to search for the predefined event or pattern.

14. The apparatus of claim 8 wherein the detected predefined events or patterns are consumed downstream by a downstream analytic.
